(19) United States
(12) Patent Application Publication
(10) Pub. No.: US 2024/0126628 A1
(43) Pub. Date: Apr. 18, 2024

(54) COMMUNICATION DEVICE, COMMUNICATION FAILURE MANAGEMENT METHOD, FAILURE MANAGEMENT PROGRAM, AND COMMUNICATION SYSTEM

(71) Applicant: Nippon Telegraph and Telephone Corporation, Tokyo (JP)

(72) Inventor: Mizuki TATENO, Musashino-shi, Tokyo (JP)

(21) Appl. No.: 18/276,501

(22) PCT Filed: Feb. 16, 2021
(86) PCT No.: PCT/JP2021/005657

§ 371 Date: Aug. 9, 2023

(51) Int. Cl. G06F 11/07

(52) U.S. Cl. CPC G06F 11/073; G06F 11/0793

(57) ABSTRACT

When a CRAM error detection unit (12c) detects a one-bit soft error of a CRAM (12b), a failure management unit (16) performs control for coping with a failure in a downstream side communication device (14) with an error notification (ER1) as a trigger. A failure detection sensitivity of a failure detection unit (15) is temporarily increased compared to a steady state. Or an upstream side communication device (11) retransmits an original communication signal (SG1). Or a known test signal is transmitted from the upstream side communication device (11) before retransmission, and the failure is diagnosed on the downstream side, and then the test signal is retransmitted. Alternatively, a signal is processed by two communication paths to select a signal without an error, and an erroneous signal is discarded. When a failure is detected, a device is restarted. It is possible to find a failure in an early stage to prevent a silent failure or to shorten a time until recovery of service or to suppress an occurrence of a failure by taking measures with the detection of a CRAM error as a trigger.

### TECHNICAL FIELD

The present invention relates to a communication device, a communication failure management method, a failure management program, and a communication system, and in particular, the present invention relates to a countermeasure against the fact that a soft error affects a failure of a communication device.

### BACKGROUND ART

A temporary soft error may occur in a memory inside a communication equipment due to an influence of neutron rays derived from cosmic rays. In particular, in recent years, miniaturization of semiconductors has progressed, and the probability of occurrence of soft errors derived from cosmic rays has increased. In many cases, the failure of the communication equipment caused by such a soft error can be prevented by using an error correction function provided in the memory. The inventors have reported the verification result of the effectiveness of an error correction/detection function by using an actual communication equipment in NPL 1.

However, as reported by the present inventors in NPL 2, even when the error correction function is used, there is a case where the soft error affects the occurrence of the failure in the communication equipment. For example, when an error occurs in a CRAM (Configuration Random Access Memory) existing in an internal circuit of a programmable device such as an FPGA (field-Programmable Gate Array), communication information is processed by the FPGA and a result affects the failure of the communication equipment on the downstream side before the error is corrected and a logic circuit constituted by the FPGA is corrected to a correct logical configuration, as a result, communication services and the like may be affected.

### CITATION LIST

### Non Patent Literature

[NPL 1] Tateno and other, “Experimental results of soft error effect on a network equipment with error correction and detection function”, technical committee on network systems of the Institute of Electronics, Information and Communication Engineers, March 2020.
[NPL 2] Tateno, “Analysis of faults caused by CRAM error in a network equipment”, 2020 IEICE society conference, September 2020.

### SUMMARY OF INVENTION

### Technical Problem

Due to a mechanism of the soft error generated on the CRAM as described above, in a relatively large-scale communication facility operated by a communication carrier or the like, an occurrence of the failure is notified at a position different from the position where the error has occurred, and may cause a silent failure. Further, according to experiments by using an actual machine of communication facility, it has been confirmed that even if a CRAM error is corrected, a time of about 10 seconds is required from the occurrence of the CRAM error to the notification of the failure at another place.

The present invention has been made in view of the above situation, and an object is to find a failure in an early stage to prevent a silent failure or to shorten a time until recovery of service by taking measures with the detection of a CRAM error as a trigger, or to provide a communication device, a communication failure management method, a failure management program and a communication system that can suppress a failure occurrence.

### Solution to Problem

A communication device of the present invention is a communication device including one or more downstream side communication units that receive and process a signal inputted from an upstream side and a preprocessing unit having a programmable device that processes a signal on an upstream side of the downstream side communication unit, and includes a CRAM error detection unit that detects an error in a CRAM that determines a logical configuration inside the programmable device and
a downstream failure processing unit that executes at least one of investigation, suppression, and recovery of a failure occurring in the downstream side communication unit due to the upstream side error in response to the occurrence of the upstream side error detected by the CRAM error detection unit. The other inventions will be described in detail in the following embodiments.

### Advantageous Effects of Invention

According to a communication device, a communication failure management method, a failure management program, and a communication system of the present invention, it is possible to find a failure in an early stage to prevent a silent failure or to shorten a time until recovery of service by taking measures with the detection of a CRAM error as a trigger, or to suppress a failure occurrence.

### BRIEF DESCRIPTION OF DRAWINGS

FIG. 1 is a block diagram showing a configuration example-1 of a communication device according to an embodiment of the present invention.

FIG. 2 is a flowchart showing a main operation example of the communication device shown in FIG. 1.

FIG. 3 is a block diagram showing a configuration example-2 of the communication device according to the embodiment of the present invention.

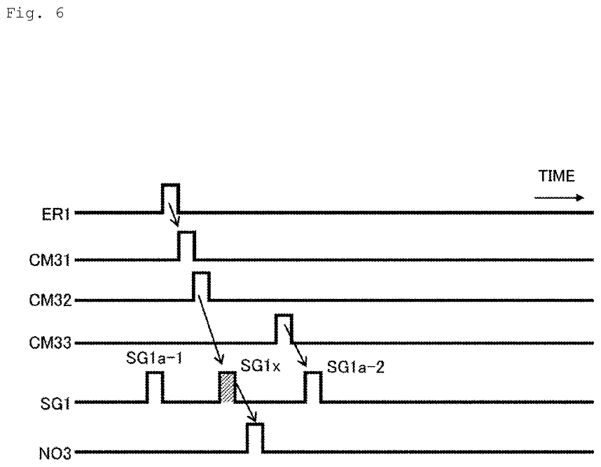

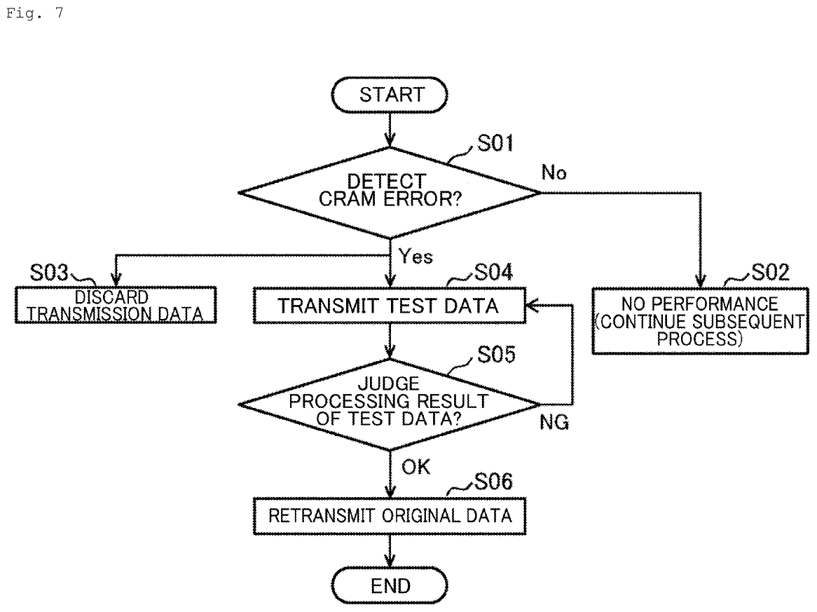

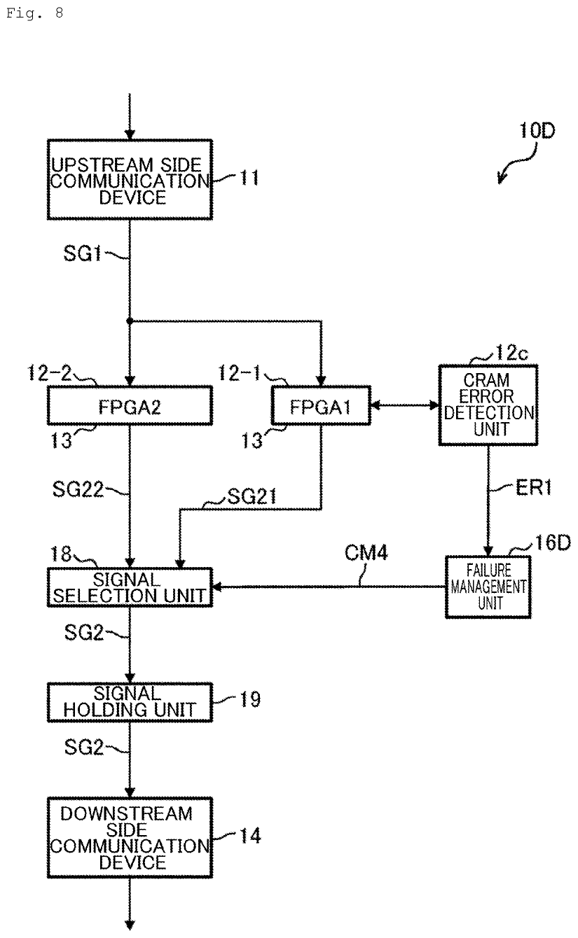

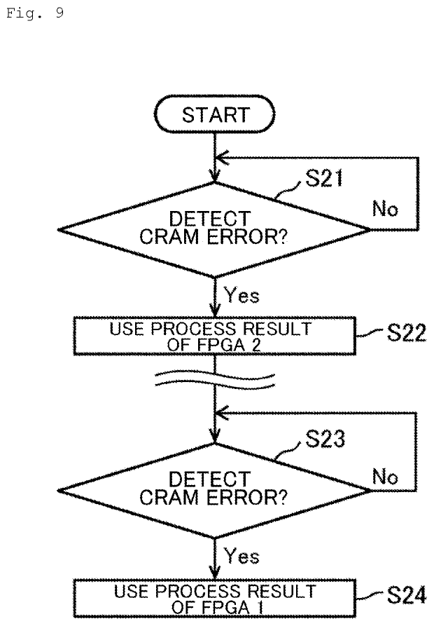

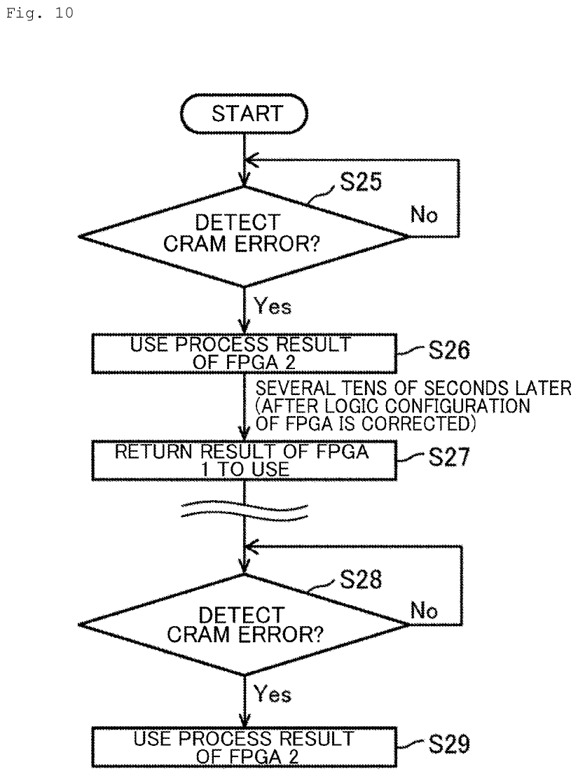

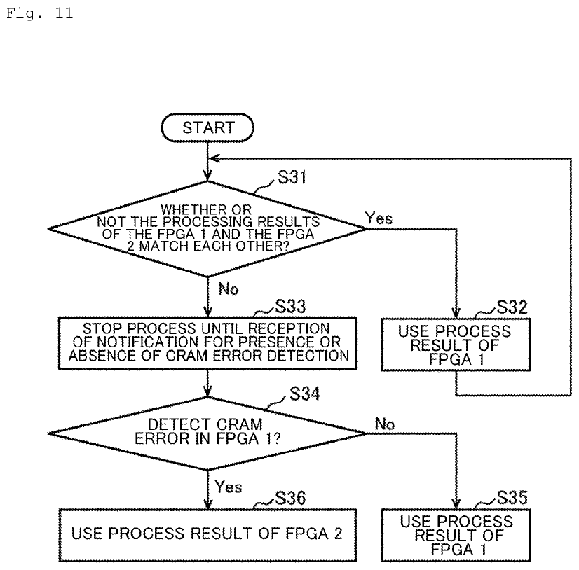

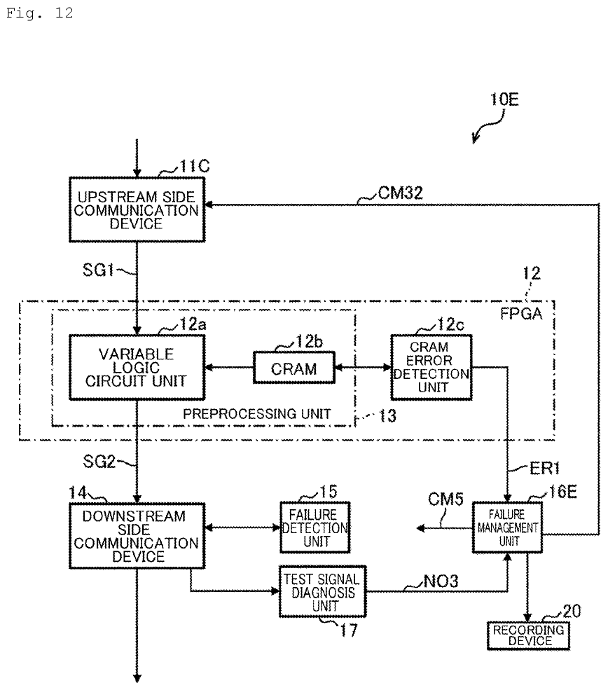

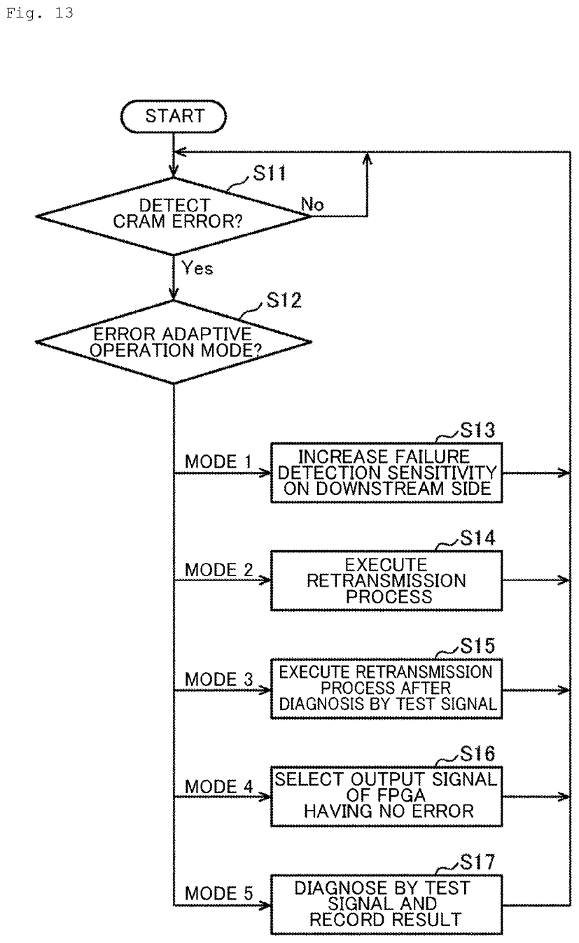

FIG. 2 is a flowchart showing a main operation example of the communication device shown in FIG. 3.

FIG. 3 is a block diagram showing a configuration example-3 of the communication device according to the embodiment of the present invention.

FIG. 2 is a flowchart showing a main operation example of the communication device shown in FIG. 5.

FIG. 7 is a flowchart showing a main operation example of the communication device shown in FIG. 5.

FIG. 3 is a block diagram showing a configuration example-4 of the communication device according to the embodiment of the present invention.

FIG. 9 is a flowchart showing an operation example-1 in the communication device shown in FIG. 8.

FIG. 9 is a flowchart showing an operation example-2 in the communication device shown in FIG. 8.

FIG. 9 is a flowchart showing an operation example-3 in the communication device shown in FIG. 8.

FIG. 3 is a block diagram showing a configuration example-5 of the communication device according to the embodiment of the present invention.

FIG. 13 is a flowchart showing an operation example of a communication system according to the embodiment of the present invention.

### DESCRIPTION OF EMBODIMENTS

An embodiment of the present invention will be described below with reference to the drawings.

### Configuration Example-1 of Communication Device

### <Description of Basic Configuration>

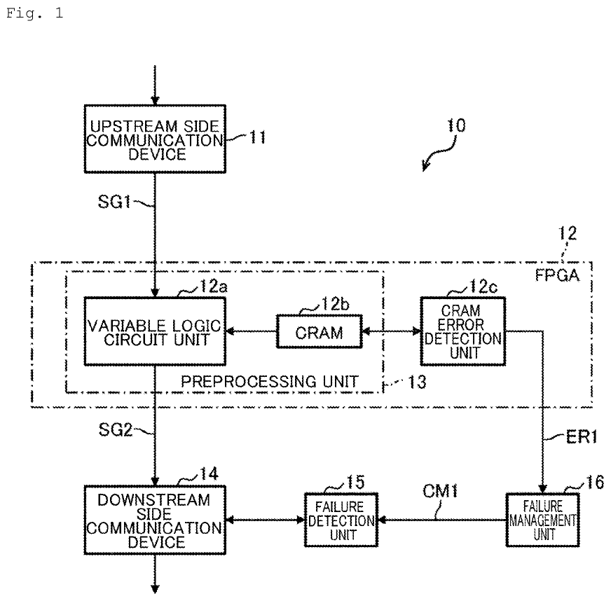

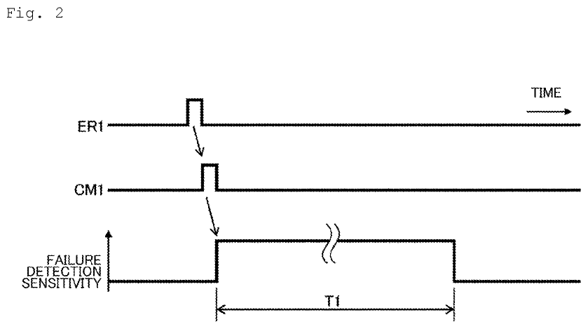

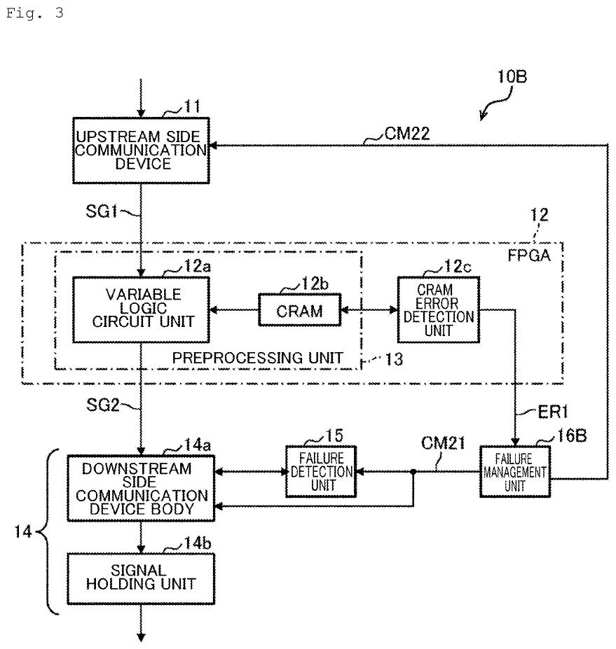

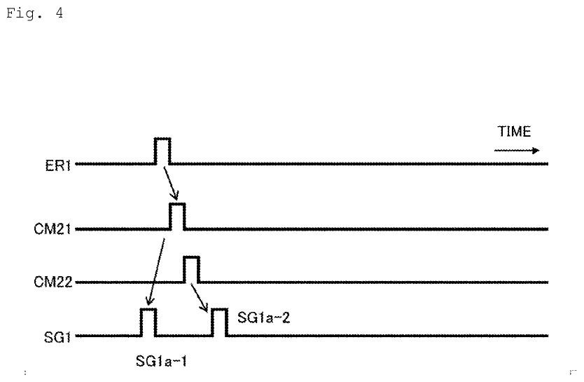

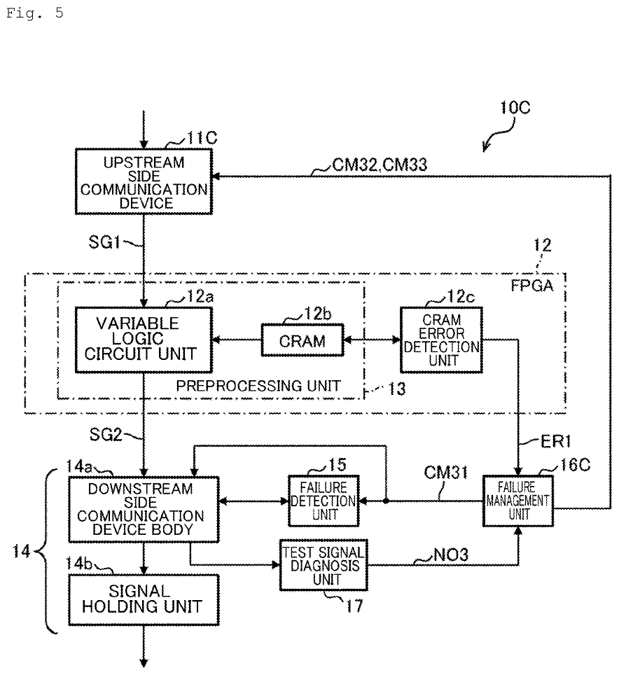

FIG. 1 shows a configuration example-1 of a communication device according to an embodiment of the present invention.

A communication device 10 shown in FIG. 1 can be used as a communication function of a part of a communication system in which a communication carrier provides various communication services to various subscribers, for example. For example, it is assumed that the communication device 10 is used as at least a part of various communication equipment included in a base station on a base station network providing wireless communication services, each transmission device existing on a transmission network, and a communication equipment of each core node existing on a core network.

The communication device 10 shown in FIG. 1 includes an upstream side communication device 11, an FPGA board 12, and a downstream side communication device 14 as equipment for processing information to be transmitted by communication. That is, information transmitted by the communication device 10 by communication is first inputted to the upstream side communication device 11, a communication signal SG1 outputted by the upstream side communication device 11 is inputted to the FPGA board 12, and a communication signal SG2 outputted by the FPGA board 12 is inputted to the downstream side communication device 14.

The FPGA board 12 realizes a function of a preprocessing unit 13 required for generating a communication signal SG2 on the downstream side from the communication signal SG1 on the upstream side. Actually, the integrated circuit of the FPGA mounted on the circuit board of the FPGA board 12 constitutes the preprocessing unit 13.

The preprocessing unit 13 is provided with a variable logic circuit unit 12a and a CRAM 12b as main components. That is, the logic circuit configuration of the variable logic circuit unit 12a is determined according to contents of data written in the CRAM 12b, and contents of process in the preprocessing unit 13 are determined.

### <Description of Items to be Considered>

Important items to be considered here is that there is a possibility that a soft error occurs inside the CRAM 12b. That is, with the miniaturization of the semiconductor, the probability of occurrence of soft errors derived from cosmic rays is increased. Therefore, a bit different from original data programed in advance in the CRAM 12b is generated by the soft error, and an error may occur in the logic circuit configuration of the variable logic circuit unit 12a.

Then, a CRAM error detection unit 12c is incorporated in the integrated circuit or on the FPGA board 12 to detect the error. Since the CRAM 12b is an ECC (Error Correction Code) memory and a redundant bit is added to each data, the CRAM error detection unit 12c can detect the occurrence of soft errors based on the redundant bit. The CRAM error detection unit 12c detects the error in the CRAM for determining the logical configuration inside the programmable device. Actually, detection and error correction are possible for one-bit error, and only detection is possible for two-bit errors.

When only one-bit error occurs here, the CRAM error detection unit 12c automatically corrects the error by utilizing the ECC, so that the problem of the FPGA itself can be avoided. Therefore, an alarm is not normally outputted for the one-bit soft error. In the case of 2-bit errors, it is possible to prevent the influence of the error from being enlarged in the downstream side communication equipment by generating an alarm, for example, by restarting the system.

However, since the CRAM error detection unit 12c sequentially scans the whole storage area of the CRAM 12b to detect an error, a certain time is required from the occurrence of the error to the correction of the error. As a result, a temporal abnormal communication signal SG2 is inputted from the FPGA board 12 to the downstream side communication device 14 due to an erroneous circuit configuration of the variable logic circuit unit 12a generated in a state before the soft error generated in the CRAM 12b is corrected. The abnormal communication signal SG2 is spread to a failure on the downstream side communication device 14 side, and an alarm is not outputted, so that there is a possibility that a silent failure whose cause is unknown is caused and damage is expanded.

### <1 Bit Soft Error Countermeasure: Automatic Adjustment of Failure Detection Sensitivity>

The communication device 10 shown in FIG. 1 is provided with a failure detection unit 15 and a failure management unit 16 as a one-bit soft error countermeasure in the CRAM 12b. These failure detection unit 15 and failure management unit 16 operate as a downstream failure processing unit for executing at least one process among investigation, suppression, and recovery of a failure occurring in the downstream side communication device 14 due to the upstream side error in response to the occurrence of the upstream side error detected by the CRAM error detection unit 12c. Also, the CRAM error detection unit 12c is configured to transmit an error notification ER1 when a one-bit soft error occurs. When receiving the error notification ER1 from the CRAM error detection unit 12c, the failure management unit 16 transmits a sensitivity change instruction CM1 to the failure detection unit 15. The failure detection unit 15 temporarily increases the sensitivity of failure detection in the downstream side communication device 14 compared with that in a steady state according to the sensitivity change instruction CM1 from the failure management unit 16. Thus, the failure management unit 16 operates as a sensitivity adjustment instruction unit for at least temporarily increasing the failure detection sensitivity of the failure detection unit 15 compared with that in a steady state in response to the occurrence of the upstream side error.

Increasing the sensitivity of the failure detection in the downstream side communication device 14 means shortening the time required from the occurrence of any abnormality to the actual detection of the caused failure by the failure detection unit 15, that is, the delay time of the detection.

As a representative example, it is assumed that, when a correct signal does not appear on the downstream side communication device 14 within a certain protection time, the failure detection unit 15 monitoring the signal detects a failure. In this case, for example, by changing the threshold value of the protection time from “2 seconds” in a steady state to “1 second”, the delay time of detection is shortened, and the detection sensitivity to the failure is improved.

As an example other than the above, it is assumed that, when the number of times of detection in the case where an erroneous signal is continuously detected on the downstream side communication device 14 becomes abnormal, the failure detection unit 15 monitoring the abnormal state detects a failure. In this case, for example, by changing the threshold value of the number of times of continuous detection regarded as abnormality from “4” in a steady state to “3”, the delay time of detection is shortened, and the detection sensitivity to the failure is improved.

When a failure in the downstream side communication device 14 is detected, the failure detection unit 15 shown in FIG. 1 notifies a system (EMS: Element Management System) for managing the occurrence of a failure, an operator of a monitoring center, and the like of the failure. In this case, a recovery measure such as restarting a device affected by a failure such as the downstream side communication device 14 can be performed at an early stage by an instruction of an operator at a remote place or autonomous determination of a device in EMS or the like.

Note that, since the failure of the device caused by the soft error is temporary, the device is recovered to a normal state by restarting the device. Further, in the above description, it is assumed that the failure detection unit 15 detects the occurrence of a soft error at an early stage on the assumption that the failure detection is sooner or later surely performed. On the other hand, depending on the failure mode and the detection method, the cause itself of failure may be found or automatically restored by increasing the failure detection sensitivity. In this case, there is an advantage of preventing the occurrence of the silent failure.

### Operation Example-1 of Communication Device

FIG. 2 shows a main operation example of the communication device 10 shown in FIG. 1.

When a soft error occurs in the CRAM 12b, the CRAM error detection unit 12c detects it and transmits an error notification ER1 as shown in FIG. 2. The failure management unit 16 transmits a sensitivity change instruction CM1 according to the received error notification ER1. The failure detection unit 15 increases the failure detection sensitivity to the downstream side communication device 14 according to the received sensitivity change instruction CM1.

On the other hand, the threshold value parameters such as the protection time for the failure detection unit 15 to detect the failure are often set to an optimum value in advance in the actual environment of the communication device. Therefore, it is desirable that the parameter of the failure detection sensitivity such as the protection time be returned to the normal setting after the CRAM error detection unit 12c detects the 1-bit soft error of the CRAM 12b and the bit error is corrected and the variable logic circuit unit 12a has a correct logical configuration.

Then, the failure detection unit 15 or the failure management unit 16 automatically controls so as to return to the normal failure detection sensitivity when a predetermined control period T1 elapses after the failure detection sensitivity is increased as shown in FIG. 2. The length of the control period T1 is, for example, about several tens of seconds. That is, after the lapse of about several tens of seconds after the CRAM error detection unit 12c detects the 1-bit soft error of the CRAM 12b, the bit data of the CRAM 12b is error-corrected and the variable logic circuit unit 12a is estimated to be restored to a correct logical configuration, so that the failure detection sensitivity can be returned to a normal state.

Note that when a 2-bit soft error is generated in the CRAM 12b, the error cannot be corrected, and when the error is detected, the CRAM error detection unit 12c informs a system EMS managing the occurrence of the failure and an operator of a monitoring center of the failure.

In an actual machine, it is usually about several tens of msec to detect a CRAM error. In addition, it is also assumed that about several msec is required to increase the failure detection sensitivity of the downstream device after the CRAM error is detected. Of course, these values depend on the structure of the circuit and the device, and it is necessary to adjust the timing appropriately so that the entire communication system can perform an appropriate operation in accordance with the actual device environment.

### Configuration Example-2 of Communication Device

FIG. 3 shows a communication device 10B of a configuration example-2 according to the embodiment of the present invention. FIG. 4 shows a main operation example of the communication device 10B shown in FIG. 3. The communication device 10B shown in FIG. 3 is a modification example of the communication device 10 shown in FIG. 1, and the same components are indicated by the same reference numerals in FIGS. 1 and 3.

The communication device 10B shown in FIG. 3 is provided with an upstream side communication device 11, an FPGA board 12, and a downstream side communication device 14 like the communication device 10 shown in FIG. 1. In addition, the downstream side communication device 14 shown in FIG. 3 is constituted of a downstream side communication device body 14a and a signal holding unit 14b. The signal holding unit 14b has a function of temporarily holding the output of the process result in the downstream side communication device body 14a.

Further, the communication device 10B shown in FIG. 3 is provided with a failure detection unit 15 and a failure management unit 16B as a one-bit soft error countermeasure in the CRAM 12b. Also, the CRAM error detection unit 12c is configured to transmit an error notification ER1 when a one-bit soft error occurs.

When receiving the error notification ER1 from the CRAM error detection unit 12c, the failure management unit 16B shown in FIG. 3 transmits a signal discard instruction CM21 to the downstream side communication device body 14a and a failure detection unit 15, and then transmits a retransmission request CM22 to the upstream side communication device 11 after that. The failure management unit 16B operates as a discard instruction instructing unit for discarding the corresponding signal in the downstream side communication device body 14a or the signal holding unit 14b of the downstream side communication device 14 in response to the occurrence of the upstream side error.

For example, when the upstream side communication device 11 transmits a first communication signal SG1a-1 shown in FIG. 4 and an error occurs in the logical configuration of the variable logic circuit unit 12a due to the influence of the soft error occurring in the CRAM 12b, an error occurs in a communication signal SG2 as a result of processing the communication signal SG1a-1 by the preprocessing unit 13.

Then, in order to discard an erroneous communication signal SG2 corresponding to the first communication signal SG1a-1, the failure management unit 16B instructs the discard by the signal discard instruction CM21. Then, after the error in the CRAM 12b is corrected and the variable logic circuit unit 12a is corrected to a correct logical configuration, the upstream side communication device 11 transmits a second communication signal SG1a-2 as an original signal in accordance with a retransmission request CM22 as shown in FIG. 4. The content of the second communication signal SG1a-2 is the same as that of the first communication signal SG1a-1. The failure management unit 16B operates as a retransmission request unit for instructing retransmission of the corresponding signal to the upstream side communication device 11 existing on the upstream side of the preprocessing unit 13.

The timing at which the upstream side communication device 11 transmits the second communication signal SG1a-2 as retransmission is later than the timing at which the error in the CRAM 12b is corrected and correct information in the CRAM 12b is reflected on the logical configuration of the variable logic circuit unit 12a. Generally, since the error correction of the CRAM 12b takes about several tens of msec, it is necessary to set a time interval longer than this time between the two communication signals SG1a-1 and SG1a-2.

However, before the signal discard instruction CM21 is inputted to the downstream side communication device 14, there is a possibility that the process of an erroneous communication signal SG2 is already completed in the downstream side communication device 14 and is outputted to the downstream side. Then, in order to surely prevent the transmission of an erroneous signal to the downstream side of the downstream side communication device 14 before the signal discard instruction CM21 appears, the signal holding unit 14b temporarily holds the signal processed by the downstream side communication device body 14a. Then, after the timing at which the signal discard instruction CM21 is determined not to appear, the signal held in the holding state by the signal holding unit 14b is outputted to the downstream side.

For example, in the case of a design in which the signal discard instruction CM21 is transmitted at 50 msec after the CRAM error detection unit 12c detects the soft error of the CRAM 12b, when the signal discard instruction CM21 does not come even after a time longer than the time, for example, 60 msec, elapses, a process result of the communication signal SG2 corresponding to the first communication signal SG1a-1 by the downstream side communication device body 14a is outputted to the downstream side by the signal holding unit 14b, and when the signal discard instruction CM21 appears, the downstream side communication device body 14a or the signal holding unit 14b discards the instruction.

Note that when the downstream side communication device 14 exists at a position where the signal discard instruction CM21 always appears earlier than the erroneous communication signal SG2 in terms of time, the function of the signal holding unit 14b is not required, and the signal processed by the downstream side communication device body 14a can be outputted to the downstream side as it is.

In this case, the downstream side communication device 14 processes the communication signal SG2 corresponding to the first communication signal SG1a-1 and outputs the result when the signal discard instruction CM21 is not received. For example, when the communication signal SG1 reaches the input of the downstream side communication device 14 as the communication signal SG2 at 60 msec after processing by the preprocessing unit 13, the system is designed so that the signal discard instruction CM21 is transmitted to the downstream side communication device 14 within 50 msec. Note that the time required for the CRAM error detection unit 12c to detect the soft error of the CRAM 12b is generally about several tens of msec.

As a concrete method for the upstream side communication device 11 to retransmit the same communication signal SG1, it is assumed that the transmitted signal is stored in a queue inside the upstream side communication device 11. In this case, it is considered that the signal next to the queue is transmitted by discarding after a prescribed time elapses from the transmission time point, or the signal next to the queue is transmitted by discarding after receiving a discard instruction from the failure management unit 16B.

### Configuration Example-3 of Communication Device

FIG. 5 shows a communication device 10C of the configuration example-3 according to the embodiment of the present invention. FIGS. 6 and 7 show examples of operation timing and operation procedure in the communication device 10C shown in FIG. 5. The communication device 10C shown in FIG. 5 is a modification example of the communication device 10B shown in FIG. 3, and the same components are denoted by the same reference numerals in FIGS. 3 and 5.

The communication device 10C shown in FIG. 5 is provided with an upstream side communication device 11C, an FPGA board 12, and a downstream side communication device 14 like the communication device 10B shown in FIG. 3. In addition, the upstream side communication device 11C shown in FIG. 5 has a function of transmitting a known test signal. Further, the downstream side communication device 14 shown in FIG. 5 is constituted of a downstream side communication device body 14a and a signal holding unit 14b. The signal holding unit 14b has a function of temporarily holding the output of the process result in the downstream side communication device body 14a.

Further, the communication device 10C shown in FIG. 5 includes a failure detection unit 15, a failure management unit 16C, and a test signal diagnosis unit 17 as a one-bit soft error countermeasure in the CRAM 12b. Also, the CRAM error detection unit 12c is configured to transmit an error notification ER1 when a one-bit soft error occurs.

In a state where a soft error is not generated in the CRAM 12b, the CRAM error detection unit 12c does not detect the error, and the error notification ER1 is not outputted. On the other hand, when a soft error occurs in the CRAM 12b, a CRAM error detection unit 12c detects the error, executes error correction, and transmits the error notification ER1.

When receiving the error notification ER1 from the CRAM error detection unit 12c, the failure management unit 16C shown in FIG. 5 transmits a signal discard instruction CM31 to the downstream side communication device body 14a and the failure detection unit 15, and further sequentially transmits a test transmission request CM32 and a retransmission request CM33 to the upstream side communication device 11C after that. The failure management unit 16C operates as a discard instruction instructing unit for discarding a corresponding signal in the downstream side communication device 14 in response to the occurrence of the upstream side error.

For example, when the upstream side communication device 11C transmits a first communication signal SG1a-1 shown in FIG. 6 and an error occurs in the logical configuration of the variable logic circuit unit 12a due to the influence of a soft error occurring in the CRAM 12b, an error occurs in a communication signal SG2 as a result of processing the communication signal SG1a-1 by the preprocessing unit 13.

Then, in order to discard the erroneous communication signal SG2 corresponding to the first communication signal SG1a-1, the failure management unit 16C instructs discard by a signal discard instruction CM31. Then, for example, the failure management unit 16C transmits a test transmission request CM32 to the upstream side communication device 11 C in order to diagnose whether or not a problem actually occurs after a predetermined time estimated that the error in the CRAM 12b is corrected and the variable logic circuit unit 12a is corrected to a correct logical configuration has passed or before the predetermined time has passed. The failure management unit 16C operates as a test signal request unit for instructing the transmission of a known test signal to the upstream side communication device 11 existing on the upstream side of the preprocessing unit 13 in response to the occurrence of the upstream side error.

The upstream side communication device 11C transmits known information prepared in advance as the communication signal SG1 in accordance with the test transmission request CM32 as the test signal SG1x. In this case, in a state where no error occurs in the logical configuration of the variable logic circuit unit 12a in the preprocessing unit 13, information of the communication signal SG2 outputted from the variable logic circuit unit 12a to the test signal SG1x is also known. Therefore, the test signal diagnosis unit 17 performs diagnosis by comparing information of the known communication signal SG2 corresponding to the test signal SG1x with information of the communication signal SG2 actually inputted to the downstream side communication device body 14a. That is, the test signal diagnosis unit 17 executes diagnosis for confirming that there is no error in the logical configuration in the variable logic circuit unit 12a. Then, the test signal diagnosis unit 17 outputs the diagnosis result as a diagnosis result notification NO3. The test signal diagnosis unit 17 identifies whether or not the downstream side communication device 14 has obtained a correct process result for the test signal transmitted from the upstream side communication device 11C.

After confirming that there is no error in the logical configuration of the variable logic circuit unit 12a by the diagnosis result notification NO3 outputted from the test signal diagnosis unit 17, the failure management unit 16C transmits a retransmission request CM33 to the upstream side communication device 11C. The failure management unit 16C operates as a retransmission request unit for instructing the retransmission of the discarded signal to the upstream side communication device 11C after the downstream side communication device 14 obtains a correct process result to the test signal SG1x.

The upstream side communication device 11C transmits a second communication signal SG1a-2 as an original signal in accordance with the retransmission request CM33 as shown in FIG. 6. The content of the second communication signal SG1a-2 is the same as that of the first communication signal SG1a-1.

Note that before the signal discard instruction CM31 is inputted to the downstream side communication device 14, there is a possibility that the process of the communication signal SG2 in which an error occurs due to the effect of a soft error generated in the CRAM 12b is already completed in the downstream side communication device 14 and is outputted to the downstream side. In order to surely prevent the transmission of the erroneous signal to the downstream side of the downstream side communication device 14 before the signal discard instruction CM31 appears, the signal holding unit 14b temporarily holds the signal processed by the downstream side communication device body 14a. Then, after the timing at which the signal discard instruction CM31 is determined not to appear, the signal held in the holding state by the signal holding unit 14b is outputted to the downstream side.

Note that when the downstream side communication device 14 exists at a position where the signal discard instruction CM31 always appears earlier than the erroneous communication signal SG2 in terms of time, the function of the signal holding unit 14b is not required, and the signal processed by the downstream side communication device body 14a can be outputted to the downstream side as it is.

In the communication device 10C shown in FIG. 5, when a soft error occurs in the CRAM 12b, for example, as shown in FIG. 6, the error notification ER1, the signal discard instruction CM31, the test transmission request CM32, and the retransmission request CM 33 appear sequentially.

In addition, the information of the communication signal SG2 corresponding to the first communication signal SG1a-1 is discarded in the downstream side communication device body 14a or in the signal holding unit 14b by the signal discard instruction CM31. Then, after the error correction of the soft error in the CRAM 12b and the reflection of the result to the variable logic circuit unit 12a are completed, the test signal SG1x appears as the communication signal SG1 by the test transmission request CM32.

When the logical configuration of the variable logic circuit unit 12a is correctly corrected, the test signal diagnosis unit 17 recognizes that information appearing in the communication signal SG2 by the test signal SG1x coincides with information of the known communication signal SG2, and outputs the diagnosis result notification NO3. The failure management unit 16C transmits the retransmission request CM 33 by the diagnosis result notice NO3, and the upstream side communication device 11C transmits the second communication signal SG1a-2 as the retransmission.

Next, operation procedure shown in FIG. 7 will be described. When no soft error is generated in the CRAM 12b, the CRAM error detection unit 12c does not detect an error, so that the process proceeds from step S01 to S02, the failure management unit 16C does not perform anything, and the communication device 10C continues normal communication process.

On the other hand, when a soft error is generated in the CRAM 12b, the error is detected by the CRAM error detection unit 12c, so that process proceeds from steps S01 to S03 and S04. That is, the downstream side communication device body 14a discards the information of the erroneous communication signal SG2 in the step S03 in accordance with the signal discard instruction CM31, and the upstream side communication device 11C transmits known data as the test signal SG1x in accordance with the test transmission request CM32 in the step S04.

In the next step S05, the test signal diagnosis unit 17 compares information of the communication signal SG2 corresponding to the test signal SG1x with known information to perform diagnosis. By this diagnosis, whether or not there is an error in the logical configuration of the variable logic circuit unit 12a can be identified. When the presence of an error in the logical configuration is detected by the diagnosis, the process returns from the step S05 to the step S04 and the test signal SG1x is retransmitted. Note that when the diagnosis result is not OK even if the retransmission of the test signal SG1x is repeated several times, the failure management unit 16C or the failure detection unit 15 executes process for restarting the device of a related part.

When the test signal diagnosis unit 17 recognizes that there is no error in the logical configuration of the variable logic circuit unit 12a in the step S05, the process proceeds to the next step S06. That is, the failure management unit 16C transmits the retransmission request CM 33 on the basis of the diagnosis result notification NO3, and the upstream side communication device 11C transmits the same communication signal SG1a-2 as the retransmission of the original communication signal SG1a-1 in accordance with the retransmission request CM 33.

That is, in the communication device 10C shown in FIG. 5, when a soft error of the CRAM 12b occurs, after the erroneous communication signal SG2 is discarded in the downstream side communication device body 14a or in the signal holding unit 14b, the test signal diagnosis unit 17 confirms the completion of error correction by utilizing the test signal SG1x transmitted by the upstream side communication device 11C. After the confirmation, the upstream side communication device 11C performs control so as to retransmit the original communication signal SG1 from the upstream side communication device 11C. Therefore, it is considered that more reliable communication control is realized as compared with the communication device 10B shown in FIG. 3.

Note that when the diagnostic result of the test signal diagnosis unit 17 does not become OK even if the test signal SG1x is transmitted several times, there is a possibility that a failure occurs within a range that cannot be restored only by error correction of the CRAM 12b. In this case, the operation of the device is restarted to restore the device.

### Configuration Example-4 of Communication Device

FIG. 8 shows a communication device 10D of a configuration example-4 according to the embodiment of the present invention. The communication device 10D shown in FIG. 8 is a modification example of the communication device 10 shown in FIG. 1, and in FIGS. 1 and 8, the same components are denoted by the same reference numerals.

As shown in FIG. 8, the communication device 10D includes an upstream side communication device 11, two FPGA boards 12-1 and 12-2, a signal selection unit 18, a signal holding unit 19, a downstream side communication device 14, a CRAM error detection unit 12c, and a failure management unit 16D. Note that, for example, both functions of the two FPGA boards 12-1 and 12-2 may be collectively arranged on one circuit board.

The two FPGA boards 12-1 and 12-2 shown in FIG. 8 have the function of a preprocessing unit 13, respectively, and the two preprocessing units 13 are connected in parallel so that the communication signal SG1 can be processed through independent communication paths. The FPGA boards 12-1 and 12-2 correspond to a first programmable device circuit and a second programmable device circuit connected in parallel to the signal path.

In general, the integrated circuit of the FPGA has a function for detecting the CRAM 12b and its soft error and correcting an error in addition to the variable logic circuit unit 12a. Also, in the communication device 10D shown in FIG. 8, the CRAM error detection unit 12c can individually detect the soft error of the CRAM in each of the two FPGA boards 12-1 and 12-2 and correct the error. In addition, the CRAM error detection unit 12c specifies the FPGA board 12-1 or 12-2 in which an error has occurred when detecting a soft error of the CRAM in any of the FPGA boards 12-1 and 12-2, and transmits the error notification ER1 to the failure management unit 16D.

Note that although the CRAM error detection unit 12c shown in FIG. 8 has functions of detecting the soft error of the CRAM and correcting the error in each of the two FPGA boards 12-1 and 12-2, the function of transmitting the error notification ER1 to the error of one standby system of the two FPGA boards 12-1 and 12-2 may be omitted.

The communication signal SG1 transmitted by the upstream side communication device 11 is branched into two systems and processed by respective preprocessing units 13 of the two FPGA boards 12-1 and 12-2. Then, communication signals SG21 and SG22 outputted from the two systems of preprocessing units 13 are simultaneously inputted to the signal selection unit 18.

The failure management unit 16D outputs a selection control instruction CM4 according to the state of the error notice ER1 transmitted by the CRAM error detection unit 12c. The signal selection unit 18 selects either one of the two system communication signals SG21 and SG22 in accordance with the selection control instruction CM4 inputted from the failure management unit 16D and outputs it as the communication signal SG2. Further, the signal selection unit 18 discards a signal which is not selected out of the two system communication signals SG21 and SG22 in accordance with the selection control instruction CM4. The communication signal SG2 outputted by the signal selection unit 18 is inputted to the downstream side communication device 14 via the signal holding unit 19.

However, there is a possibility that the erroneous communication signal SG2 is inputted to the downstream side communication device 14 before the signal selection unit 18 selects a correct signal by the selection control instruction CM4. Then, the signal holding unit 19 holds the output of the communication signal SG2 to the downstream side until a correct signal among the two system communication signals SG21 and SG22 is determined. Then, after it is determined that the communication signal SG2 selected by the signal selection unit 18 is a correct signal, the signal holding unit 19 outputs the communication signal SG2 in the holding state to the downstream side.

Note that when the signal selection unit 18 is arranged at a position where the state of the selection control instruction CM4 is determined before the erroneous communication signal appears in any of the communication signals SG21 and SG22, the erroneous communication signal can be surely discarded inside the signal selection unit 18, and the function of the signal holding unit 19 is not required. That is, the failure management unit 16D operates as a selection instruction unit for instructing the signal selection unit 18 to select one signal not related to the error among the signal outputted by the FPGA board 12-1 and the signal outputted by the FPGA board 12-2 in response to the occurrence of the upstream side error.

### Operation of Configuration Example-4

FIGS. 9, 10 and 11 show operation examples-1, -2 and -3 of the communication device 10D shown in FIG. 8, respectively.

### Operation Example-1

The operation example shown in FIG. 9 shows an operation for selecting one of the two system communication signals SG21 and SG22 by the signal selection unit 18 of the communication device 10D. When no soft error occurs in the CRAM 12b, the preprocessing units 13 of the two FPGA boards 12-1 and 12-2 perform the same process, so that no problem occurs even if the signal selection unit 18 selects either of the two system communication signals SG21 and SG22. In the present embodiment, the signal selection unit 18 selects one communication signal SG21 in the initial state.

In a step S21 shown in FIG. 9, the CRAM error detection unit 12c identifies the presence or absence of an error in the CRAM 12b in a currently selected system out of two FPGA boards 12-1 and 12-2.

Since the communication signal SG21 on the FPGA board 12-1 side is in a selected state in an initial state, when the CRAM error detection unit 12c detects a CRAM error in the FPGA board 12-1 in the step S21, the process proceeds to the next step S22. Thereafter, the signal selection unit 18 selects the FPGA 2 in the non-selected state, that is, the other communication signal SG22 outputted from the FPGA board 12-2 and the state is switched in a step S22 so that the communication signal SG21 selected so far is discarded. Note that the FPGA board 12-1 or 12-2 on the side where the CRAM error occurs becomes a standby system as the next switching destination after the error of the CRAM 12b is corrected.

In addition, in the next step S23, since the communication signal SG22 is in a selected state, the CRAM error detection unit 12c identifies the presence or absence of an error in the CRAM 12b in the system of the FPGA board 12-2. Then, when an error of the CRAM 12b is detected in the step S23, the process proceeds to the next step S24. Thereafter, the signal selection unit 18 selects the FPGA1 in a non-selected state, that is, the communication signal SG21 outputted from the FPGA board 12-1 and switches the state in the step S24 so that the communication signal SG22 selected so far is discarded.

In other words, in the operation example shown in FIG. 9, the signal selection unit 18 selects a system in which no CRAM error is detected from the communication signals SG21 and SG22 of two systems, and alternately switches the system every time the CRAM error is detected.

However, since it is assumed that several tens of msec are actually required from the detection of the error of the CRAM 12b to the reflection of the result on the selection state of the signal selection unit 18, there is a possibility that the erroneous communication signal SG21 or SG22 is temporarily outputted to the downstream side before the selection state is correctly switched. Therefore, it is necessary to prevent the erroneous signal from being outputted by utilizing the function of the signal holding unit 19, for example.

### Operation Example-2

The operation example shown in FIG. 10 shows an operation for selecting one of the two system communication signals SG21 and SG22 by the signal selection unit 18 of the communication device 10D. When no soft error occurs in the CRAM 12b, the preprocessing units 13 of the two FPGA boards 12-1 and 12-2 perform the same process, so that no problem occurs even if the signal selection unit 18 selects either of the two system communication signals SG21 and SG22. In the present embodiment, the signal selection unit 18 selects one communication signal SG21 in the initial state and in the steady state.

In a step S25 shown in FIG. 10, the CRAM error detection unit 12c identifies the presence or absence of an error in the CRAM 12b in a currently selected system among two FPGA boards 12-1 and 12-2.

Since the communication signal SG21 on the FPGA board 12-1 side is in a selected state in an initial state, when the CRAM error detection unit 12c detects a CRAM error in the FPGA board 12-1 in the step S25, the process proceeds to the next step S26. Thereafter, the signal selection unit 18 selects the FPGA 2 in a non-selected state, that is, the other communication signal SG22 outputted by the FPGA board 12-2 and switches the state in a step S26 so that the communication signal SG21 selected so far is discarded.

On the other hand, when a soft error occurs in the CRAM 12b, the error is reflected and an error occurs in the logical configuration of the variable logic circuit unit 12a, but a one-bit error on the CRAM 12b is automatically error-corrected by using ECC by the CRAM error detection unit 12c. In addition, the error correction result on the CRAM 12b is also reflected on the logical configuration of the variable logic circuit unit 12a at least after a fixed time. Therefore, even if a soft error occurs, when the preprocessing unit 13 of the FPGA in which the error occurs is used again in a steady state after a predetermined time has elapsed, no problem occurs.

Then, when a fixed time, for example, several tens of seconds elapses after the execution of the step S26, the communication device 10D proceeds to the next step S27. In the step S27, the signal selection unit 18 selects the FPGA1, that is, the communication signal SG21 outputted by an FPGA board 12-1 and returns the state to the same state as the initial state so as to discard the communication signal SG22 selected so far.

In addition, in the next step S28, since the communication signal SG21 is in the selected state similarly to the initial state, the CRAM error detection unit 12c identifies the presence or absence of an error in the CRAM 12b in the system of the FPGA board 12-1. Then, when the communication device 10D detects an error of the CRAM 12b in the step S28, the process proceeds to the next step S29.

In the step S29, the signal selection unit 18 selects the FPGA 2 in a non-selected state, that is, the communication signal SG22 outputted by the FPGA board 12-2 and switches a state so that the communication signal SG21 selected so far is discarded.

In other words, in the operation example shown in FIG. 10, in the initial state and the steady state, the signal selection unit 18 preferentially selects one communication signal SG21 of the two systems of communication signals SG21 and SG22, and temporarily selects the communication signal SG22 of the system in which no error occurs only when the CRAM error is detected.

### Operation Example-3

The operation example shown in FIG. 11 shows an operation for selecting one of the two system communication signals SG21 and SG22 by the signal selection unit 18 of the communication device 10D. In the operation example shown in FIG. 11, the control is performed by paying attention to the coincidence/non-coincidence of the communication signals SG21 and SG22 which are the process results of the preprocessing unit 13 in the two system FPGA boards 12-1 and 12-2.

That is, when no soft error of the CRAM 12b occurs in any of the two-system FPGA boards 12-1 and 12-2, since the logical configuration of the two system variable logic circuit units 12a are equal, the two communication signals SG21 and SG22 coincide. Conversely, when the communication signals SG21 and SG22 coincide, it can be estimated that no CRAM error occurs in both the FPGA boards 12-1 and 12-2. In this case, therefore, no problem occurs even if the signal selection unit 18 selects either of the communication signals SG21 and SG22.

On the other hand, when a soft error of the CRAM 12b occurs in any of the two-system FPGA boards 12-1 and 12-2, a difference occurs in the logical configuration of the two-system variable logic circuit unit 12a, and therefore, the two communication signals SG21 and SG22 do not coincide with each other. In this case, it is necessary to select one of the two system communication signals SG21 and SG22 which is not affected by the error by the signal selection unit 18 and to discard the information of the one which is affected by the error.

In a step S31 shown in FIG. 11, the signal selection unit 18 compares information of two system communication signals SG21 and SG22 to identify whether they are coincident or not. That is, the presence or absence of a CRAM error is identified by comparing communication signals SG21 and SG22 which are process results of the preprocessing units 13 of the two system FPGA 1 and the FPGA 2.

When the comparison result of the step S31 is coincident, since no CRAM error occurs, the communication device 10D proceeds to the process of a step S32. In this case, although there is no problem even if either of the two communication signals SG21 and SG22 is selected, the signal selection unit 18 preferentially selects the communication signal SG21 which is a process result of the preprocessing unit 13 in one FPGA 1 in the example of FIG. 10 in the step S32.

When the comparison result in the step S31 is not coincident, there is a possibility that a CRAM error occurs in either one of the two systems of FPGA 1 and FPGA 2. Therefore, in the next step S33, the signal selection unit 18 temporarily stops the process until the notification of the CRAM error comes. Then, the communication device 10D proceeds to the next step S34.

Note that, in the communication device 10D shown in FIG. 8, the CRAM error detection unit 12c can detect a CRAM error generated in either of the two-system FPGA boards 12-1 and 12-2. However, in the operation example shown in FIG. 11, it is assumed that the CRAM error detection unit 12c detects only the CRAM error generated in one FPGA board 12-1.

In the step S34, the failure management unit 16D identifies whether or not the CRAM error detection unit 12c detects a CRAM error in one FPGA board 12-1.

A state in which the CRAM error detection unit 12c does not detect the CRAM error in the FPGA board 12-1 in the step S34 means a state in which the CRAM error occurs in the other FPGA board 12-2. Therefore, in a step S35, the failure management unit 16D outputs the selection control instruction CM4 to control so that the signal selection unit 18 selects the communication signal SG21 being a process result of the FPGA board 12-1 side where a CRAM error does not occur. In this case, the information of the communication signal SG22 is discarded by the signal selection unit 18.

When the CRAM error detection unit 12c detects a CRAM error in the FPGA board 12-1 in the step S34, the communication device 10D proceeds to a step S36. In the step S36, the failure management unit 16D outputs the selection control instruction CM4 to control so that the signal selection unit 18 selects the communication signal SG22 which is a process result of the FPGA board 12-2 side where a CRAM error does not occur. In this case, the information of the communication signal SG21 which is not selected is discarded by the signal selection unit 18.

When the communication device 10D executes the operation shown in FIG. 11, when the two system communication signals SG21 and SG22 coincide, it is estimated that a CRAM error does not occur, so that the signal selection unit 18 does not need to wait for a time required for the selection control instruction CM4 to reach due to the detection of the CRAM error. Therefore, in this case, since the signal selection unit 18 can transmit one of the communication signals SG21 and SG22 to the downstream side communication device 14 at an early stage, the process speed is expected to be improved.

Note that, a general FPGA device is mounted with the function of the CRAM error detection unit 12c excluding the function of transmitting the error notification ER1, the variable logic circuit unit 12a, and the CRAM 12b. That is, the two FPGA boards 12-1 and 12-2 shown in FIG. 8 are structurally symmetrical, and the same result is obtained even if the left and right “FPGA 1” and “FPGA 2” are replaced. In addition, in the operation shown in FIG. 11, “FPGA 1” and “FPGA 2” can be replaced with each other.

On the other hand, as for the function of the CRAM error detection unit 12c, the operation shown in FIG. 11 can be executed if the CRAM error detection unit 12c is mounted only on either one of “FPGA 1” and “FPGA 2”. For example, when the FPGA board 12-1 of the “FPGA 1” is used as an active system and the FPGA board 12-2 of the “FPGA 2” is used as a standby system at the time of failure, the function of the CRAM error detection unit 12c may be mounted only on the FPGA board 12-1.

In this case, when a CRAM error occurs in the active system “FPGA 1”, the “FPGA 1” is switched to the standby system “FPGA 2”, and when the FPGA 1 is recovered from the failure state after the lapse of a fixed time, the switching-back is performed similarly to the step S27 shown in FIG. 10, so that an operation form in which the process result of the active system “FPGA 1” is always used at a normal time is also assumed.

That is, in the case of executing the operation shown in FIG. 11, since it is not necessary to mount the function of the CRAM error detection unit 12c on the standby system side, the facility cost of the communication device 10D can be reduced.

In addition, in the case of a general majority circuit, two or more identical process results are selected from the process results of the triple circuit. However, in the case of the communication device 10D shown in FIG. 8, the preprocessing unit 13 is only duplicated by FPGA boards 12-1 and 12-2, and the reliability of the communication system can be improved while suppressing complication of the structure.

### Configuration Example-5 of Communication Device

FIG. 12 shows a communication device 10E of a configuration example-5 according to the embodiment of the present invention. The communication device 10E shown in FIG. 12 is a modification example of the communication device 10C shown in FIG. 5, and the same components are denoted by the same reference numerals in FIGS. 5 and 12.

The communication device 10E of FIG. 12 includes an upstream side communication device 11C, an FPGA board 12, and a downstream side communication device 14. The upstream side communication device 11C shown in FIG. 12 has a function of transmitting a known test signal.

Further, the communication device 10E shown in FIG. 12 includes a failure detection unit 15, a failure management unit 16E, a test signal diagnosis unit 17 and a recording device 20 as a one-bit soft error countermeasure in the CRAM 12b. Also, the CRAM error detection unit 12c transmits an error notification ER1 when a one-bit soft error occurs.

Each of the communication devices 10, 10B, 10C, 10D has a function corresponding to a situation in which a soft error generated in the CRAM 12b causes an error generation of the communication signal SG2 on the downstream side. However, even if a CRAM error occurs, there is no influence on the device. For example, when the logical configuration of an unused area in the variable logic circuit unit 12a is changed due to the CRAM error, the communication signal SG2 is not affected, so that a failure does not occur in the operation of the downstream side communication device 14. In other words, even if a CRAM error occurs, it is not always necessary to handle the CRAM error as a failure of the device.

On the other hand, the investigation of what influence appears on the downstream side communication device 14 with respect to the occurrence of the CRAM error in the FPGA board 12 is considered to be useful for early finding the error affecting the communication device and preventing the silent failure. Further, it is assumed that the communication device does not return to the normal operation only by correcting the CRAM error when the CRAM error occurs.

Then, in the communication device 10E shown in FIG. 12, when the CRAM error detection unit 12c outputs the error notification ER1, the failure management unit 16E gives the test transmission request CM32 to the upstream side communication device 11C for investigation.

The upstream side communication device 11C transmits the test signal SG1x composed of known information as the communication signal SG1 in accordance to the test transmission request CM32. The test signal SG1x is processed by the preprocessing unit 13 of the FPGA board 12 and inputted to the downstream side communication device 14 as the communication signal SG2.

Since the test signal diagnosis unit 17 grasps correct information of the communication signal SG2 actually inputted to the downstream side communication device 14 with respect to the test signal SG1x and correct information appearing in each internal part or the like of the downstream side communication device 14 in advance as known information, it is possible to diagnose and investigate whether or not a failure actually occurs and a range to which the failure has spread. The diagnosis result is outputted from the test signal diagnosis unit 17 as the diagnosis result notification NO3.

When receiving the diagnosis result notification NO3, the failure management unit 16E outputs the information of the diagnosis result to the recording device 20 and records it, and transmits a restart instruction CM5 to a device of each part of the communication system such as the downstream side communication device 14 when the diagnosis result having a problem is inputted. That is, the whole communication system is restored to a normal state even for a failure which cannot be restored only by error correction to the CRAM error by the output of the restart instruction CM5.

### Operation Example of Communication System

FIG. 13 shows an operation example of the communication system according to the embodiment of the present invention. A main part of the communication system (not shown) for performing the operation shown in FIG. 13 is similar to that of the communication devices 10, 10B, 10C, 10D, and 10E described above, and is configured to include all components and all functions in the communication devices 10 to 10E, for example. In addition, the failure management unit 16 of the communication system is constituted so that a plurality of types of CRAM error coping functions provided in the communication devices 10 to 10E can be executed selectively or in combination by switching operation modes. Further, each of the processes shown in FIG. 13 is constructed as a program executable by a computer for controlling the failure management unit 16, for example. The operation shown in FIG. 13 will be described below.

In a step S11, the CRAM error detection unit 12c identifies the presence or absence of the occurrence of a one-bit soft error in the CRAM 12b. When an error occurs, since the error notification ER1 is outputted from the CRAM error detection unit 12c, the failure management unit 16 identifies whether a current selection state of an error coping operation mode is any one of a mode 1, a mode 2, a mode 3, a mode 4, and a mode 5 in the next step S12.

When the mode 1 is selected, the failure management unit 16 performs process in a step S13 so as to increase the failure detection sensitivity on the downstream side by the sensitivity change instruction CM1 in the same way as the case of the communication device 10 shown in FIG. 1. The process in the step S13 corresponds to first process in which the failure management unit 16 temporarily increases the sensitivity of failure detection in the downstream side communication device 14.

When the mode 2 is selected, the failure management unit 16 performs process in a step S14 so that the upstream side communication device 11 retransmits the original signal by the output of the signal discard instruction CM21 and the retransmission request CM22 in the same way as the case of the communication device 10B shown in FIG. 3. The process in the step S14 corresponds to second process in which the failure management unit 16 instructs the upstream side communication device 11 existing on the upstream side of the preprocessing unit 13 to retransmit a signal corresponding to the failure.

When the mode 3 is selected, the failure management unit 16 performs process in a step S15 so that the upstream side communication device 11C retransmits the original signal after diagnosing by the test signal by the outputs of the signal discard instruction CM31, the test transmission request CM32 and the retransmission request CM33 in the same way as the case of the communication device 10C shown in FIG. 5. The process in the step S15 corresponds to third process in which the failure management unit 16 instructs the upstream side communication device 11 to transmit a known test signal and diagnoses a process result of the downstream side communication unit with respect to the test signal.

When the mode 4 is selected, the failure management unit 16 performs process in a step 16 so that the communication signal SG21 or SG22 outputted by the FPGA where no error occurs is selected by the output of the selection control instruction CM4 in the same way as the case of the communication device 10D shown in FIG. 8. The process of the step S16 corresponds to fourth process in which the failure management unit 16 selects one normal path out of the duplexed paths in the preprocessing unit 3.

When the mode 5 is selected, the failure management unit 16 records the diagnosis result for the test signal in the same way as the case of the communication device 10E shown in FIG. 12, and outputs the restart instruction CM5 when there is a problem in the diagnosis result to process the operation of the system in a step S17 so as to be recovered.

In the operation example shown in FIG. 13, although five types of processes of modes 1 to 5 correspond to the occurrence of CRAM error, a plurality of processes of modes 1 to 5 can be combined and simultaneously executed.

As a specific example, it is conceivable to combine the processes of modes 4 and 2. For example, although a situation where CRAM errors occur almost simultaneously in both the two system FPGA 1 and FPGA 2 shown in FIG. 8 is very low probability, the possibility of occurrence may be considered. Even in this case, when the failure management unit 16 deals with the combination of the modes 4 and 2, it is possible to prevent a situation where the erroneous communication signal SG2 is outputted to the downstream side communication device 14 side and a failure occurs.

### <Advantage of Each Communication Device>

In each of the communication devices 10 to 10E, since the failure management unit 16 takes appropriate measures with the soft error of the CRAM 12b detected by the CRAM error detection unit 12c as a trigger, a failure occurring on the downstream side communication device 14 side can be prevented in advance or recovered to a normal state. Thus, influence on service provision to a user using the communication device 10 can be suppressed.

In addition, in the case of the communication device 10 shown in FIG. 1, since the failure management unit 16 corresponding to a sensitivity adjustment instruction unit makes failure detection sensitivity at least temporarily higher than that in a steady state in response to the occurrence of a CRAM error on the upstream side, the occurrence of the failure can be detected early, and an influence of the failure can be suppressed from spreading to the downstream side.

Further, in the case of the communication device 10B shown in FIG. 3, the failure management unit 16B corresponding to a discard instruction instructing unit and a retransmission request unit instructs the discard of the signal corresponding to the error, and requests the upstream side communication device 11 to retransmit the corresponding signal. Therefore, it is possible to prevent a temporary error caused in the logical configuration of the variable logic circuit unit 12a due to the CRAM error from affecting the downstream side communication device 14.

In addition, in the case of the communication device 10C shown in FIG. 5, the failure management unit 16C as a discard instruction instructing unit instructs the discard of a corresponding signal to the CRAM error by the signal discard instruction CM31, the failure management unit 16C as a test signal request unit requests the transmission of the known test signal by the test transmission request CM32, and the failure management unit 16C requests the retransmission by the retransmission request CM33 when a correct process result to the test signal is obtained. Therefore, the original communication signal SG1 is retransmitted after confirming that the error of the logical configuration of the variable logic circuit unit 12a is restored, and the reliability is improved.

Further, in the case of the communication device 10D shown in FIG. 8, it is necessary to prepare the two system programmable device circuits FPGA 1 and FPGA 2 in advance, but it is not necessary to wait until an error generated in the logical configuration of either one of the variable logic circuit units 12a is restored. That is, since the signal selection unit 18 can select a signal having no error out of the two system communication signals SG21 and SG22 and output it in a short time, it is useful for improving the response speed of the communication device 10D.

In addition, in the communication devices 10 to 10E, the CRAM error detection unit 12c detects an error in the CRAM for determining a logical configuration inside the FPGA, and failure management units 16 to 16E perform at least one process of investigation, suppression, and recovery of a failure occurring in the downstream side communication device 14 due to the error in the CRAM when an error detection in the CRAM occurs. Therefore, when the erroneous communication signal SG2 is outputted due to a CRAM error occurring in the FPGA, it is possible to appropriately cope with a failure occurring on the downstream side communication device 14 side.

Further, by reading and executing the failure management program including the respective process procedures shown in FIG. 13 by a computer such as the failure management unit 16, when the erroneous communication signal SG2 is outputted due to a CRAM error occurring in the FPGA, it is possible to appropriately cope with a failure occurring in the downstream side communication device 14 side.

Further, the communication system equipped with the functions of the respective process procedures shown in FIG. 13 can select an appropriate operation mode from among a plurality of kinds of operation modes as necessary, and can appropriately cope with a failure occurring on the downstream side communication device 14 side when an erroneous communication signal SG2 is output due to a CRAM error occurring in the FPGA.

The configurations and function effect of the present invention will be described below.

(1) A communication device of the present invention is a communication device including one or more downstream side communication units that receive and process a signal inputted from an upstream side and a preprocessing unit having a programmable device that processes a signal on an upstream side of the downstream side communication unit, and includes a CRAM error detection unit that detects an error in a CRAM that determines a logical configuration inside the programmable device, and
a downstream failure processing unit that executes at least one of investigation, suppression, and recovery of a failure occurring in the downstream side communication unit due to the upstream side error in response to the occurrence of the upstream side error detected by the CRAM error detection unit.

According to the communication device of the present invention, when an error occurs in a logical configuration inside the programmable device due to a soft error of the CRAM, it is possible to suppress an erroneous communication signal outputted from the programmable device from causing a failure in a function of communication equipment on a downstream side thereof.

(2) The communication device according to (1) wherein the downstream failure processing unit includes a failure detection unit that detects a failure in the downstream side communication unit, and
a sensitivity adjustment instruction unit that, in response to the occurrence of the upstream side error, increases a failure detection sensitivity of the failure detection unit at least temporarily as compared to a steady state.

According to the communication device having the configuration (2) described above, the sensitivity adjustment instruction unit makes the failure detection sensitivity at least temporarily higher than that in a steady state in response to the occurrence of a CRAM error on the upstream side, the occurrence of the failure cane be detected at an early stage and the influence of the failure can be suppressed from spreading to the downstream side.

(3) The communication device according to (1) or (2) wherein the downstream failure processing unit includes a discard instruction instructing unit that discards a corresponding signal in the downstream side communication unit in response to the occurrence of the upstream side error, and a retransmission request unit that instructs an upstream side communication unit existing on an upstream side of the preprocessing unit to retransmit a corresponding signal.

According to the communication device having the configuration (3) described above, the discard instruction instructing unit instructs the discard of the signal corresponding to the error, and the retransmission request unit requests the upstream side communication unit to retransmit the corresponding signal. Therefore, it is possible to avoid the influence of a temporary error caused in the logical configuration of the programmable device due to the CRAM error on the downstream side communication unit.

(4) The communication device according to (1) or (2) wherein the downstream failure processing unit includes a discard instruction instructing unit the discards a corresponding signal in the downstream side communication unit in response to the occurrence of the upstream side error, a test signal request unit that instructs the upstream side communication unit existing on an upstream side of the preprocessing unit to transmit a known test signal in response to the occurrence of the upstream side error,
a test signal diagnosis unit that identifies whether or not the downstream side communication unit has obtained a correct process result for the test signal transmitted from the upstream side communication unit, and
a retransmission request unit that instructs the upstream side communication unit to retransmit the discarded signal after the downstream side communication unit obtains a correct process result for the test signal.

According to the communication device having the configuration (4) described above, the discard instruction instructing unit instructs the discard of the corresponding signal to the CRAM error, the test signal requesting unit requests the transmission of the known test signal, and the retransmission requesting unit requests the retransmission when a correct process result is obtained for the test signal. Therefore, the original communication signal is retransmitted after confirming that the error of the logical configuration of the programmable device is restored, and the reliability is improved.

(5) The communication device according to any one of (1) to (4) wherein
the preprocessing unit includes a first programmable device circuit and a second programmable device circuit connected in parallel to a signal path, and
the downstream failure processing unit includes a selection instruction unit that instructs the downstream side communication unit to select one signal not related to an error among a signal outputted by the first programmable device circuit and a signal outputted by the second programmable device circuit in response to the occurrence of the upstream side error.

According to the communication device having the configuration (5) described above, it is necessary to prepare two systems of the first programmable device circuit and the second programmable device circuit in advance, but it is not necessary to wait until an error occurring in the logical configuration of either one of the programmable devices is restored. That is, since a signal having no error can be selected from the two system communication signals and outputted in a short time by the instruction of the selection instruction unit, it is useful for improving the response speed of the communication device.

(6) A communication failure management method according to the present invention is a communication failure management method that manages a failure in a communication device including one or more downstream side communication units that receive and process a signal inputted from an upstream side and a preprocessing unit having a programmable device that processes a signal on an upstream side of the downstream side communication unit, and include
detecting an error in a CRAM that determines a logical configuration inside the programmable device, and
executing at least one process of investigation, suppression, and recovery of a failure occurring in the downstream side communication unit due to an error of the CRAM when error detection occurs in the CRAM.

According to the communication failure management method of the present invention, when an error occurs in a logical configuration inside the programmable device due to a soft error of the CRAM, it is possible to suppress an erroneous communication signal outputted from the programmable device from causing a failure in a function of communication equipment on a downstream side thereof.

(7) A failure management program of the present invention is a failure management program executable by a computer that manages a failure in a communication device including one or more downstream side communication units that receive and process a signal inputted from an upstream side and a preprocessing unit having a programmable device that processes a signal on an upstream side of the downstream side communication unit, and include
a procedure for detecting an error in a CRAM that determines a logical configuration inside the programmable device, and a procedure for executing at least one process of investigation, suppression, and recovery of a failure occurring in the downstream side communication unit due to an error of the CRAM when error detection occurs in the CRAM.

By executing the failure management program of the present invention by a predetermined computer, when an error occurs in a logical configuration inside the programmable device due to a soft error of the CRAM, it is possible to suppress an erroneous communication signal outputted from the programmable device from causing a failure in a function of communication equipment on a downstream side thereof.

(8) A communication system of the present invention includes one or more downstream side communication units that receive and process a signal inputted from an upstream side, a preprocessing unit having a programmable device that processes a signal on an upstream side of the downstream side communication unit, and a failure management unit that manages a failure in the downstream side communication unit, and includes
a CRAM error detection unit that detects an error in a CRAM that determines a logical configuration inside the programmable device, wherein
the failure management unit can execute one or more processes among a first process of temporarily increasing sensitivity of failure detection in the downstream side communication unit, a second process of instructing an upstream side communication unit existing on an upstream side of the preprocessing unit to retransmit a signal corresponding to a failure, a third process of instructing the upstream side communication unit to transmit a known test signal and diagnosing a process result of the downstream side communication unit for the test signal, and a fourth process of selecting one normal path of duplicated paths in the preprocessing unit, and
the failure management unit is configured to execute one or more processes among the first process, the second process, the third process, and the fourth process in response to the occurrence of the upstream side error detected by the CRAM error detection unit.

According to the communication system of the present invention, when an error occurs in a logical configuration inside the programmable device due to a soft error of the CRAM, it is possible to suppress an erroneous communication signal outputted from the programmable device from causing a failure in a function of communication equipment on a downstream side thereof.

### REFERENCE SIGNS LIST

10, 10B, 10C, 10D, 10E Communication device
11, 11C Upstream side communication device
12, 12-1, 12-2 FPGA board
12a Variable logic circuit unit
12b CRAM
12c CRAM error detection unit
13 Preprocessing unit
14 Downstream side communication device
14a Downstream side communication device body
14b Signal holding unit
15 Failure detection unit
16, 16B, 16C, 16D, 16E Failure management unit
17 Test signal diagnosis unit
18 Signal selection unit
19 Signal holding unit
20 Recording device
ER1 Error notification
CM1 Sensitivity change instruction
CM21, CM31 Signal discard instruction
CM22, CM33 Retransmission request
CM32 Test transmission request
CM4 Selection control instruction
CM5 Restart instruction
NO3 Diagnosis result notification
SG1, SG2, SG21, SG22 Communication signal
SG1x Test signal
T1 Control period

1. A communication device comprising:
one or more downstream side communication units, including one or more processors, that are configured to receive and process a signal inputted from an upstream side;
a preprocessing unit, including one or more processors, having a programmable device that is configured to process a signal on an upstream side of the downstream side communication unit, the preprocessing unit comprising:
a Configuration Random Access Memory (CRAM) error detection unit, including one or more processors, configured to detect an upstream side error in a CRAM that determines a logical configuration inside the programmable device; and
a downstream failure processing unit, including one or more processors, configured to execute at least one of investigation, suppression, and recovery of a failure occurring in a respective downstream side communication unit in response to the detection of the upstream side error by the CRAM error detection unit.

2. The communication device according to claim 1 wherein the downstream failure processing unit comprises:
a failure detection unit, including one or more processors, configured to detect a failure in a downstream side communication unit; and
a sensitivity adjustment instruction unit, including one or more processors, configured to, in response to the detection of the upstream side error, increase a failure detection sensitivity of the failure detection unit at least temporarily as compared to a steady state.

3. The communication device according to claim 1, wherein the downstream failure processing unit comprises:
a discard instruction instructing unit, including one or more processors, configured to discard a corresponding signal in the respective downstream side communication unit in response to the detection of the upstream side error; and
a retransmission request unit, including one or more processors, configured to instruct an upstream side communication unit existing on an upstream side of the preprocessing unit to retransmit a corresponding signal.

4. The communication device according to claim 1, wherein the downstream failure processing unit comprises:
a discard instruction instructing unit, including one or more processors, configured to discard a corresponding signal in a downstream side communication unit in response to the detection of the upstream side error;
a test signal request unit, including one or more processors, configured to instruct an upstream side communication unit existing on an upstream side of the preprocessing unit to transmit a known test signal in response to the detection of the upstream side error;
a test signal diagnosis unit, including one or more processors, configured to identify whether or not a downstream side communication unit has obtained a correct process result for the known test signal transmitted from the upstream side communication unit; and
a retransmission request unit, including one or more processors, configured to instruct the upstream side communication unit to retransmit the discarded corresponding signal after a downstream side communication unit obtains a correct process result for the known test signal.

5. The communication device according to claim 1, wherein the preprocessing unit comprises a first programmable device circuit and a second programmable device circuit connected in parallel to a signal path, and
the downstream failure processing unit comprises a selection instruction unit, including one or more processors, that is configured to instruct a downstream side communication unit to select one signal not related to an error among a signal outputted by the first programmable device circuit and a signal outputted by the second programmable device circuit in response to the detection of the upstream side error.

6. A communication failure management method performed by a communication device, the communication failure management method comprising:
receiving signal inputted from an upstream side;
processing, with a programmable device, the signal on an upstream side;
detecting an upstream side error in a CRAM that determines a logical configuration inside a programmable device of the communication device; and
executing at least one process of investigation, suppression, and recovery of a failure occurring in a respective downstream side communication unit in response to the detection of the upstream side error of the CRAM.

7. (canceled)

8. A communication system comprising:
one or more downstream side communication units, including one or more processors, that are configured to receive and process a signal inputted from an upstream side;
a preprocessing unit, including one or more processors, having a programmable device that is configured to process a signal on an upstream side of the downstream side communication unit;
a failure management unit, including one or more processors, that is configured to manage manages a failure in the downstream side communication unit, the preprocessing unit comprising:
a CRAM error detection unit, including one or more processors, configured to detect an upstream side error in a CRAM that determines a logical configuration inside the programmable device, wherein
the failure management unit is configured to execute one or more processes including:
a first process of temporarily increasing sensitivity of failure detection in the downstream side communication unit,
a second process of instructing an upstream side communication unit existing on an upstream side of the preprocessing unit to retransmit a signal corresponding to a failure,
a third process of instructing the upstream side communication unit to transmit a known test signal and diagnosing a process result of the downstream side communication unit for the known test signal, and
a fourth process of selecting one normal path of duplicated paths in the preprocessing unit, and
the failure management unit is configured to execute one or more processes among the first process, the second process, the third process, and the fourth process in response to the upstream side error detected by the CRAM error detection unit.
